(19) United States
(12) Patent Application Publication
(10) Pub. No.: US 2007/0098473 A1
(43) Pub. Date: May 3, 2007

(54) Tape printing apparatus and tape cassette

(76) Inventors: Geert Heyse, Sint-Katelijne-Waver (BE); Kris Vandermeulen, Bornem (BE); Jos Vleurinck, Oordegem (BE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/562,473

(22) PCT Filed: Jun. 28, 2004
(86) PCT No.: PCT/IB04/02496

§ 371 Date: Aug. 18, 2006

(30) Foreign Application Priority Data
Jun. 27, 2003 (GB) 0315148.7
Dec. 24, 2003 (GB) 0330053.0

(51) Int. Cl. B41J 2/32; B41J 3/54; B41J 29/38

(52) U.S. Cl. 400/76; 400/120.02; 400/149; 400/613; 400/621

(57) ABSTRACT

A label printer for printing on a direct thermal tape in a plurality of colours, said label printer comprising at least one print head for printing an image on said tape in said plurality of colours and an interface for selecting at least one background colour and at least one text colour.

The present invention relates to a tape printing apparatus, a tape supply for a tape printing apparatus and also to a tape cassette with a tape supply for use in a tape printing apparatus. In particular, the present invention relates to a tape printing apparatus for direct thermal printing, a tape supply comprising a tape of direct thermal media for use with a tape printing apparatus and to a tape cassette housing said tape for use in a tape printing apparatus.

Tape printing apparatus utilising direct thermal printing are known in the art. For example, the Casio KP-C10 comprises a printer for use with a PC. This printer has a tape receiving portion for receiving a roll of thermal paper tape, a platen and a thermal print head, wherein, during operation, the platen rotates and the tape passes between the platen and the print head with the print head heating the tape so as to form an image on the tape. However, this printer is only capable of printing black images on a white thermal tape.

Tape printing apparatus for colour printing have been suggested. However, these apparatus utilize cassettes having coloured ink ribbons with the coloured ink being transferred from the ink ribbon to a receiving tape using a thermal print head. For different coloured images, multiple ink ribbons of different colours are required. These may be loaded into a printer at the same time which increases the size of the apparatus. Alternatively, printing may be suspended and the ink ribbon replaced with a different colour before continuing printing in order to produce a different coloured image. This arrangement increases the time required to produce different coloured images. Also, these printers do not produce full colour images but rather print in one colour and then print in a different colour.

In an alternative arrangement, EP-A-0,641,663 discloses a tape printer capable of forming multi-colour printing utilising a single tape cassette and ink ribbon. The tape cassette is housed in the tape printer and comprises a print tape and an ink ribbon formed from different coloured ink portions at a set pitch in the lengthwise direction of the print tape. The tape printer is constructed so that ink ribbon and the print tape are transportable in a forward direction for printing, the ribbon take-up mechanism stops and the platen is moveable away from the printing section after which the tape transport mechanism reversibly transports the printing tape for over-printing of a different colour whereby a multicoloured image is generated. The single multicoloured ribbon solves the problem of having multiple ribbons. However, exact alignment for over-printing of coloured images to produce a multicoloured image is difficult and misalignment leads to images of poor quality. Furthermore, multiple over-printing, rewinding and/or replacement of ink ribbon cassette can lead to creasing of the ink ribbon or jamming of the ink ribbon and/or print receiving tape within the print mechanism.

Embodiments of the present invention aims to address one or more of the above-mentioned problems.

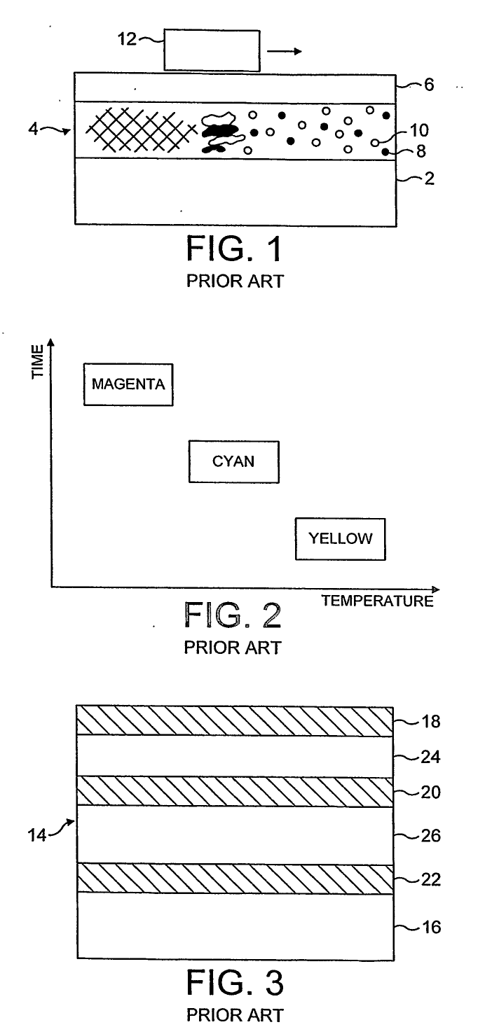

Referring to FIG. 1, a known direct thermal printing medium in the field of photography comprises a base layer 2, a print layer 4, and an overcoat layer 6. The printer layer 2 comprises an acid 8 (the developer) and a colourless die precursor 10. No reaction occurs until heat from a thermal print head 12 causes the acid 8 and the dye 10 to react, whereupon a colour is formed. The optical density of the colour increases with increasing temperature and time of heating. Monochromatic images are most commonly black and white. However, monochromatic images can be produced in different colours by using different leuco dyes.

Conventional methods for colour thermal imaging such as thermal wax transfer printing and dye diffusion thermal transfer typically involve the use of separate donor and receiver materials. However, recently various direct thermal media have been developed in the field of photography to achieve multicolour direct thermal printing. For example, WO 02/096665 discloses a multicolour imaging system wherein at least two, and preferably three, different image forming layers of a thermal imaging member are addressed at least partially independently by a thermal print head by controlling the temperature of the thermal print head and the time thermal energy is applied to the image-forming layers. Each colour of the thermal imaging member can be printed alone or in a selectable portion to the other colours. That is, the temperature-time domain is divided into regions corresponding to the different colours it is desired to combine in a final print. FIG. 2 is a graphical representation illustrating the temperature and time parameter features of such a direct thermal media for printing magenta, cyan and yellow. The temperature selected for the colour forming regions generally are in the range of from about 50° C. to about 450° C. The time period for which the thermal energy is applied to the colour forming layers of the imaging member is preferably in the range from about 0.01 to about 100 milliseconds.

A number of image-forming techniques may be exploited including thermal diffusion with buried layers, chemical diffusion or dissolution in conjunction with timing layers, melting transitions and chemical thresholds.

Referring now to FIG. 3, there is seen a pre-colour thermal imaging member that utilises thermal delays to define the printing regions for the colours to be formed. The three colour imaging member 14 includes substrate 16, cyan, magenta and yellow image-forming layers, 18, 20, 22, respectively, and spacer interlayers 24, 26.

Where the image member is heated by a thermal print head from above, the cyan image-forming layer 18 will be heated almost immediately by the thermal print head after the heat is applied, but there will be a significant delay before the magenta image-forming layer 20 and the yellow image-forming layer 22 are heated according to the thermal conductivity and thickness of the spacer layers 24, 26. To provide multicoloured printing it is preferable that each image-forming layer is arranged to be activated at a different temperature. This result can be achieved, for example, by arranging the image-forming layers to have different melting temperatures or by incorporating in them different thermal solvents, which will melt at different temperatures and liquefy the image-forming materials. For example, if the activation temperature for the cyan layer is T1, the activation temperature for the magenta layer is T2 and the activation temperature for the yellow image-forming layer is T3, then the activation temperatures may be selected such that T1>T2>T3. Accordingly, application of a temperature between T2 and T3 for a relatively long time period will produce a yellow colour without any cyan or magenta colour. A relatively short, high temperature heat pulse above T1 will produce a cyan colour without any magenta or yellow colour. Application of a temperature between T1 and T2 for a suitable length of time will produce a magenta colour. Accordingly, by varying the temperature and time of heating, individual colours or mixtures thereof may be produced so as to generate a multicolour image.

Various arrangements of layers and suitable materials for forming such layers are disclosed in WO 02/096665 and the documents cited therein.

According to the present invention, there is provided a tape supply for use in a tape printing apparatus, said tape supply comprising a roll of direct thermal image tape, said direct thermal image tape comprising a plurality of thermally activated colourants and at least one developer for producing a multi coloured image on said direct thermal image tape when said direct thermal image tape is heated.

According to the present invention, there is further provided a tape cassette for use in a tape printing apparatus, said tape cassette comprising a body housing a supply of the above-mentioned direct thermal image tape.

According to the present invention, there is further provided a tape printer comprising a tape supply receiving portion for receiving a supply of tape, a print head comprising a plurality of printing elements for printing an image on a tape, a drive means for driving a tape passed the print head and a control means for controlling the plurality of printing elements, wherein the control means is adapted to control the printing elements for producing a multicoloured image on a tape by direct thermal transfer.

According to the present invention, there is further provided a method of printing a label comprising driving a direct thermal tape passed a thermal print head and controlling the print head whereby a multicoloured image is produced on the tape by direct thermal transfer in a single pass.

Embodiments of the present invention provide a tape printing apparatus and a tape cassette/tape capable of printing monochromatic images of continuously variable optical density and/or full multicoloured images using direct thermal printing.

For a better understanding of the present invention and as to how the same may be carried into effect, reference will now be made, by way of example, to the accompanying drawings in which:

FIG. 1 shows a schematic diagram of a prior art arrangement for direct thermal printing.

FIG. 2 shows a graphical representation of the temperature-time domain for a prior art photographic medium, the temperature-time domain being divided into regions corresponding to the different colours it is desired to combine in a final print.

FIG. 3 shows the prior art photographic medium utilized to produce the divided temperature-time domain indicated in FIG. 2.

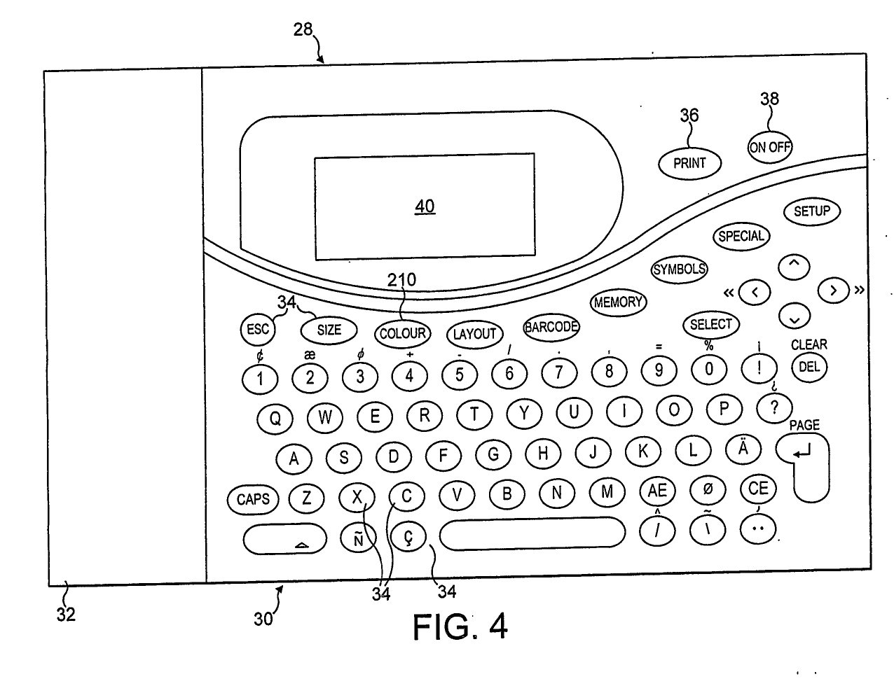

FIG. 4 shows a schematic diagram of an embodiment of a tape printing apparatus according to the present invention;

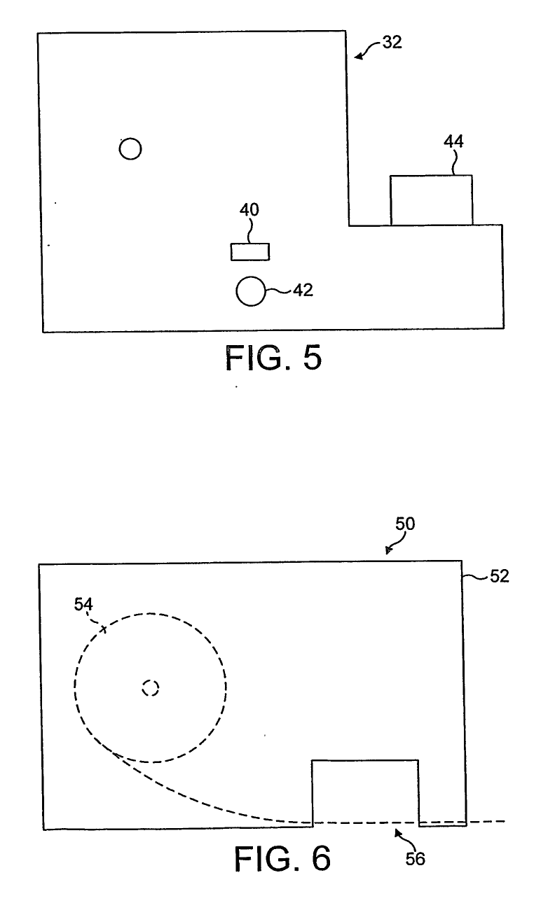

FIG. 5 shows a schematic diagram of an embodiment of a cassette receiving bay of the tape printing apparatus shown in FIG. 4;

FIG. 6 shows a schematic diagram of an embodiment of a cassette according to the present invention;

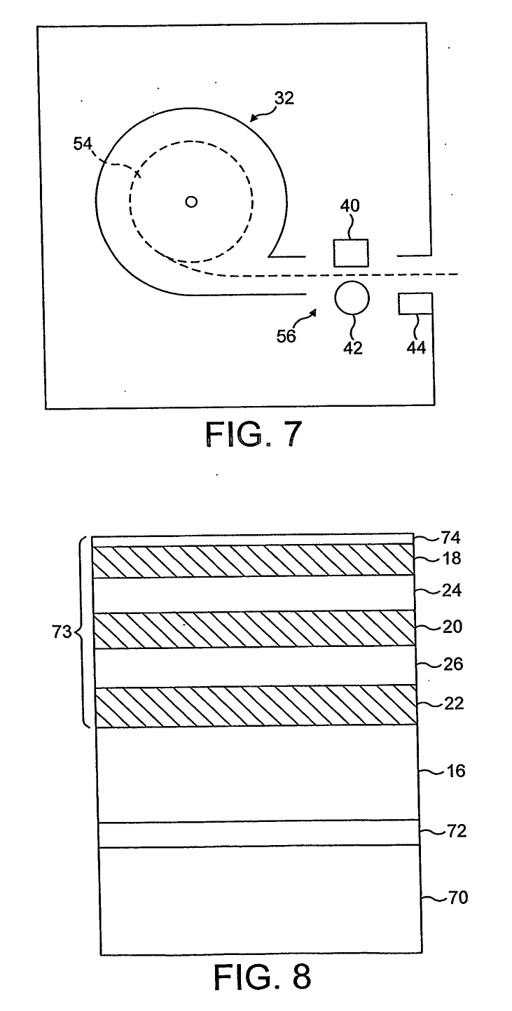

FIG. 7 shows a schematic diagram of an alternative embodiment of a direct thermal tape printer according to the present invention in which a roll of direct thermal tape is introduced directly into the tape printer;

FIG. 8 shows a schematic diagram of an embodiment of direct thermal tape according to the present invention;

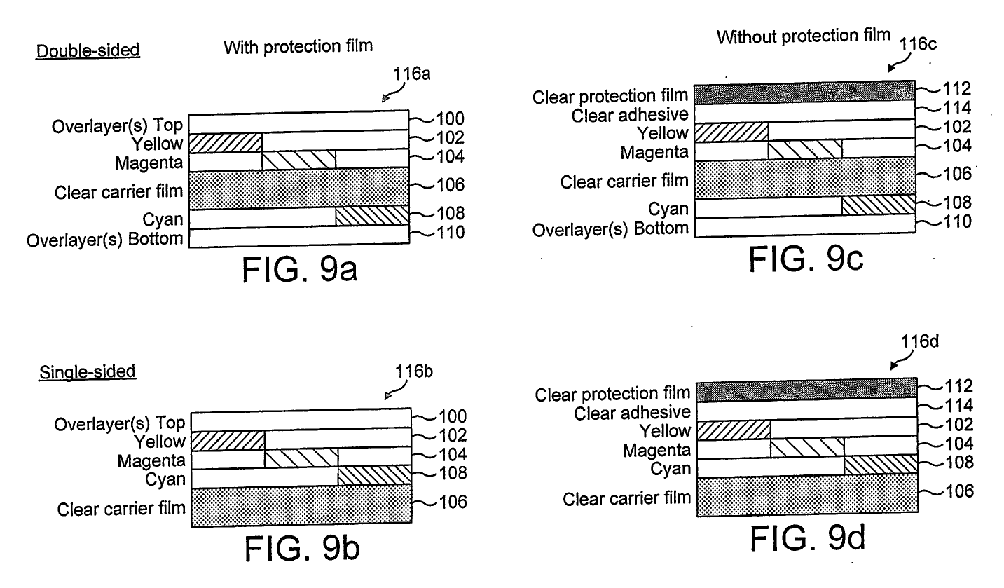

FIGS. 9a to 9d show four different examples of face material embodying the present invention;

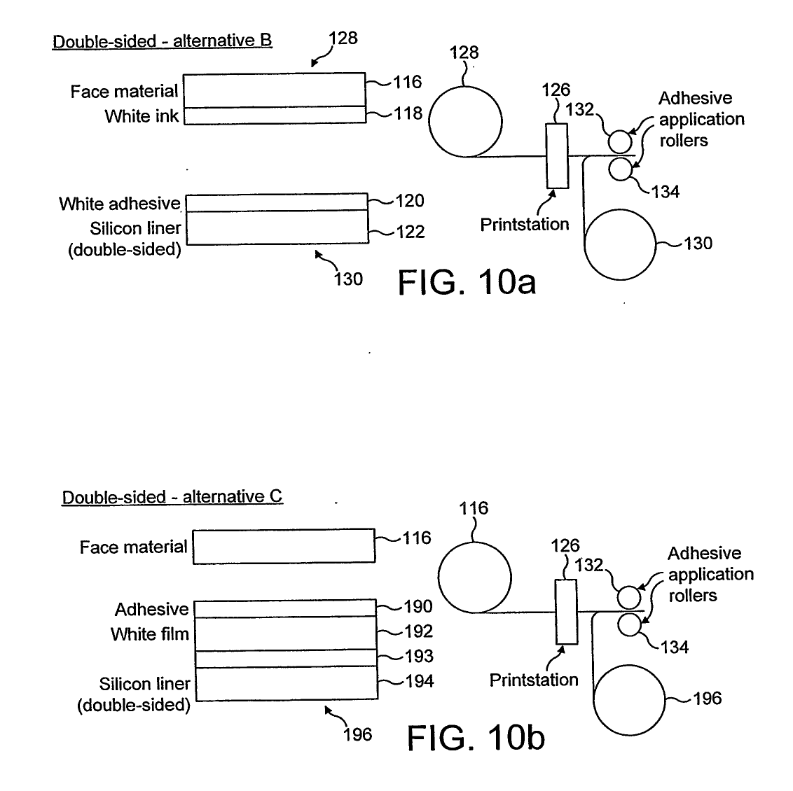

FIGS. 10a and 10b show two different examples of label material and how those materials are used in a tape printer;

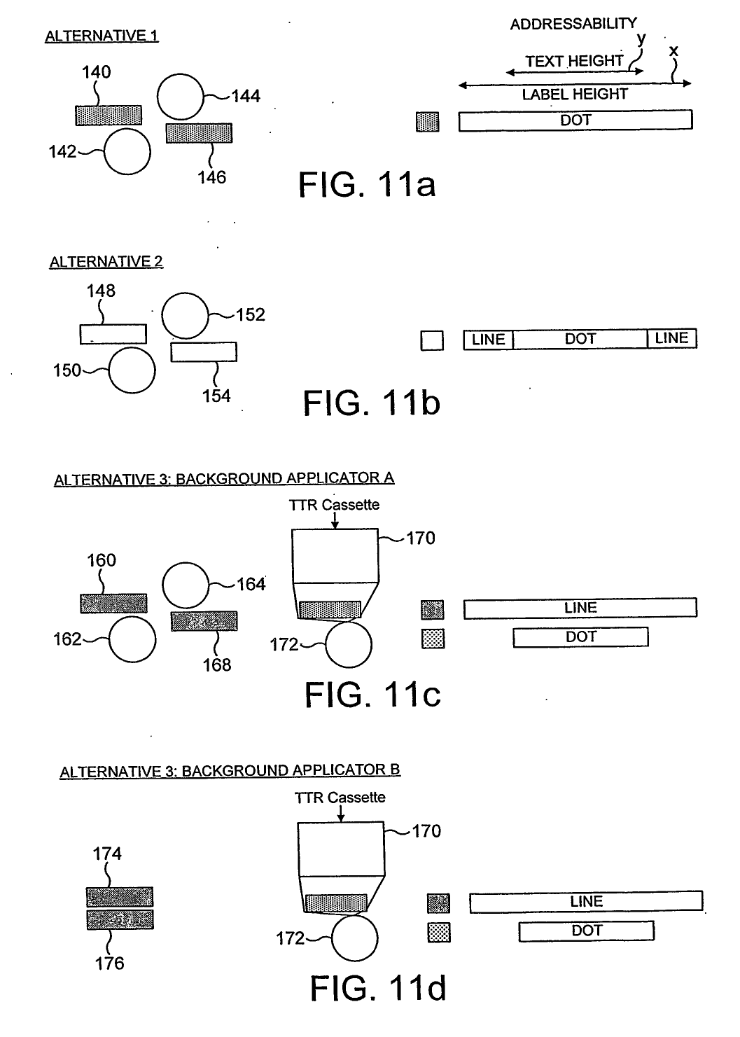

FIGS. 11a to 11d show various examples of print stations which can be used in embodiments of the present invention;

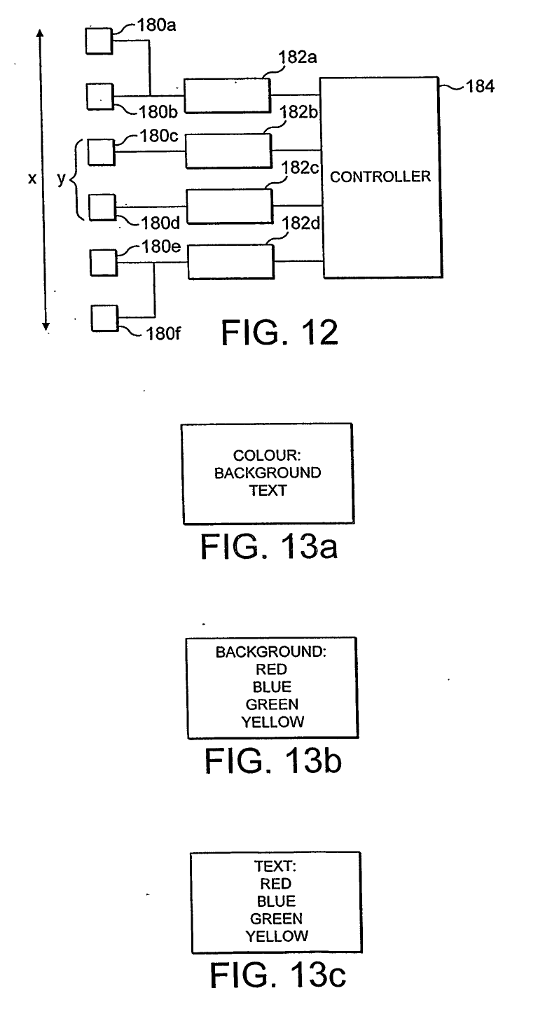

FIG. 12 shows schematically the control of a print head for use in some of the arrangements shown in FIG. 11;

FIG. 13a to 13c show various menus for selecting colours;

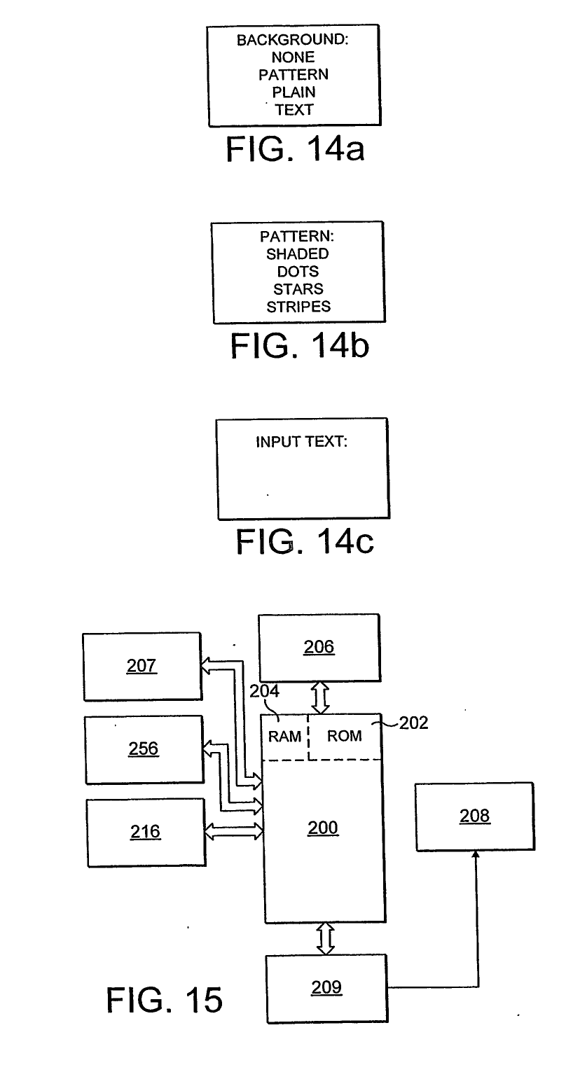

FIGS. 14a to 14c show the menus which are displayed for selecting the background of a label;

FIG. 15 shows schematically control circuitry for controlling a tape printing device embodying the present invention;

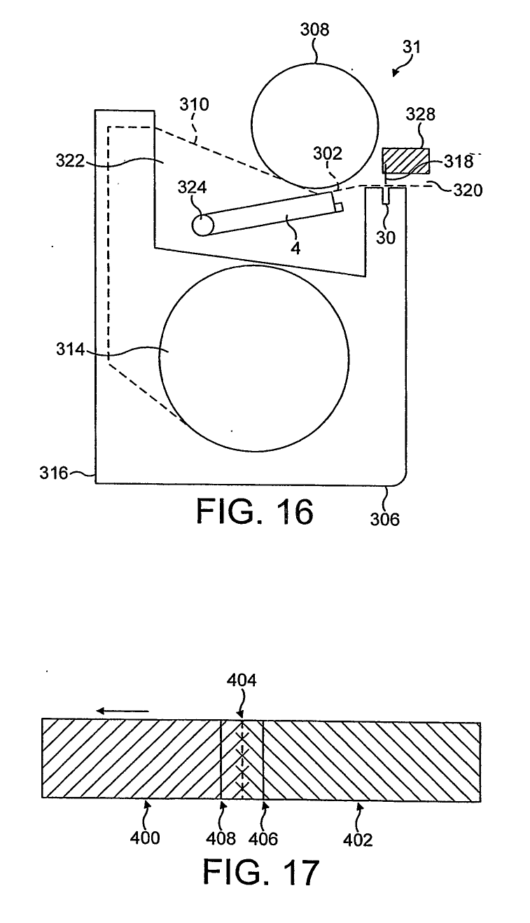

FIG. 16 shows a schematic cross sectional view of a tape printer embodying the present invention;

FIG. 17 shows an example of two labels separated by a full cut with one of the labels having a partial cut;

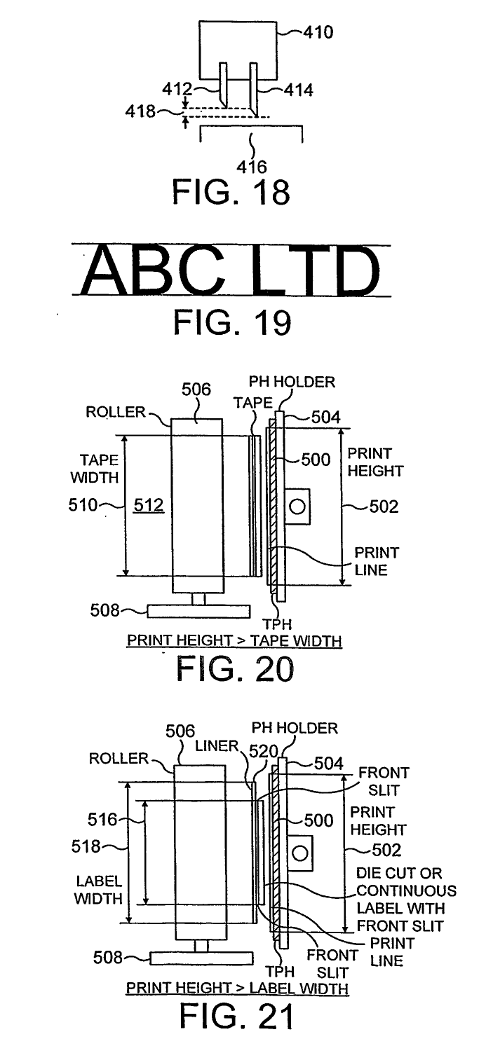

FIG. 18 shows schematically an arrangement for providing the full cut and partial cut of FIG. 17;

FIG. 19 shows a label with background printing;

FIG. 20 shows schematically the arrangement for printing a background image on a tape;

FIG. 21 shows schematically the arrangement for printing a background image on a die cut label; and

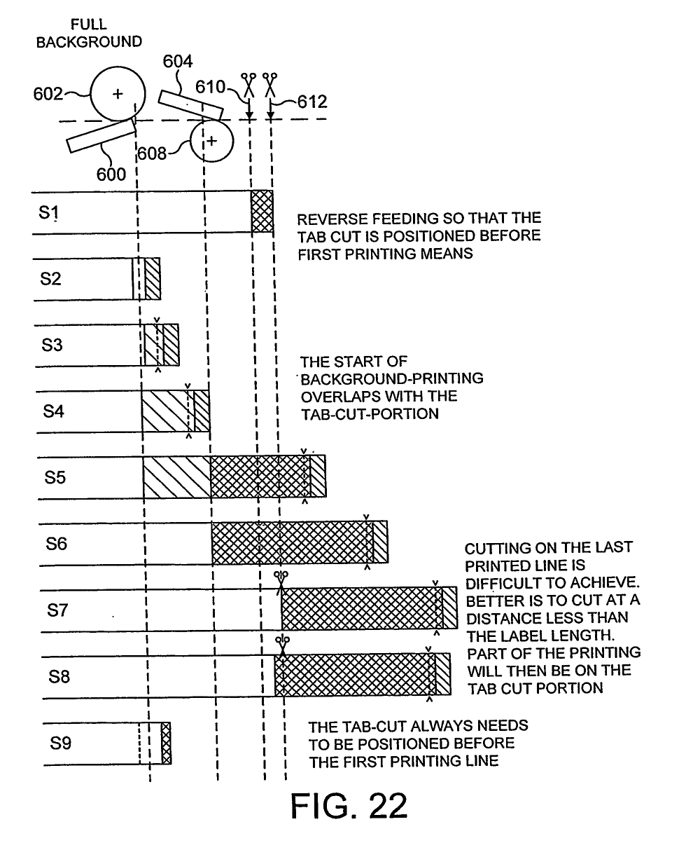

FIG. 22 illustrates an method for providing the labels of FIG. 17.

FIGS. 1 to 3 indicate prior art and have already been discussed in the pre-amble of this specification.

FIG. 4 shows a schematic diagram of an embodiment of a tape printing apparatus 28 according to the present invention. The tape printing apparatus comprises a keyboard 30 and a cassette receiving bay 32. The keyboard has a plurality of data entry keys 34 such as numbered, lettered and punctuation keys for inputting data to be printed as a label and function keys for editing the input data. The keyboard may also have a print key 36 which is operated when it is desired that a label be printed. Additionally an on/off key 38 is also provided for switching the tape printing apparatus on and off.

The tape printing apparatus has a liquid crystal display (LCD) 40 which displays the data as it is entered. The display allows the user to view all or part of the label to be printed which facilitates the editing of the label prior to its printing. Additionally, the display is driven by a display driver (not shown).

Basic circuitry for controlling the tape printing device 1 is shown in FIG. 15. There is a microprocessor chip 200 having a read only memory (ROM) 202, a microprocessor 201 and random access memory capacity indicated diagrammatically by RAM 204. The microprocessor chip 200 is connected to receive label data input to it from a data input device such as a keyboard 206. The microprocessor chip 200 outputs data to drive a display 208 via a display driver chip 209 to display a label to be printed (or a part thereof) and/or a message for the user. The display driver alternatively may form part of the microprocessor chip. Additionally, the microprocessor chip 200 also outputs data to drive the print head 216 so that the label data is printed onto the image receiving tape to form a label. Finally, the microprocessor chip 200 also controls the motor 207 for driving the platen. The microprocessor chip 100 may also control the cutting mechanism to allow a length of tape to be cut off. In alternative embodiments at least part of the cutting mechanism may be manually operated.

Reference is made to FIG. 16 which shows in plan view a tape printing device 300 embodying the present invention which has a cassette 306 arranged therein. This cassette can contain a supply of colour direct thermal material as will be discussed in more detail. The cassette 306 is located in a cassette bay 316. The cassette bay 316 also accommodates at least one thermal print head 304 and a platen 308 which cooperate to define a print zone 302. Other arrangements for the printing are describe in more detail hereinafter. The print head 3044 is able to pivot about a pivot point 324 so that it can be brought into contact with the platen 308 for printing and moved away from the platen 308 to enable the cassette 306 to be removed and replaced. In the operative position, the platen 308 is rotated to cause the image receiving tape 310 to be driven past the print head 304.

The platen 308 is driven by a DC motor (see FIG. 15) so that it rotates to drive the image receiving tape 310 through the print zone 302 of the tape printing device 301 during printing. In this way, an image is printed on the tape and fed out from the print zone 302.

The image is printed by the print head 304 on the image receiving tape 10 on a column by column basis with the columns being adjacent one another in the direction of movement of the tape 310. Pixels are selectively activated in each column to construct an image in a manner well known in the art. The DC motor is provided with a shaft encoder for monitoring the speed of rotation of the motor. The control of the speed of the motor is achieved by the microprocessor chip 100 (see FIG. 15) to generate data strobe signals each of which causes a column of pixel data to be printed by the print head 304.

The tape printing device may include at cutting location 320 a cutting mechanism 328 which carries a blade 318. The blade 318 cuts the image receiving tape 310 then enters a slot 330 located in the cassette 306.

It is understood that other embodiments of the tape printer may be envisaged. For example, the tape printer of the present invention may be a PC printer rather than a stand-alone printer. In such a printer, a keyboard and display means are not essential as the data may be input and displayed on the PC. The PC then acts as an input device for the printer. Alternatively, other apparatus may be used to input data to the printer for printing. For example, in an embodiment of the invention a digital camera may be used to input data to the tape printing device for printing. Images may alternatively be input using a smart card, chip card, memory card or the like.

FIG. 5 shows a schematic diagram of a cassette receiving bay 32 in the tape printing apparatus. The cassette receiving bay is arranged to receive a cassette housing a supply of direct thermal tape. The cassette receiving bay is generally covered by a cassette bay lid.

The cassette is intended to cooperate with a thermal printing device. The printing device carries a print head 40 and a platen 42. The print head is moveable between an operating position in which it is in contact with the platen and in which the image receiving tape is pinched between the print head and the platen and an inoperative position in which the tape is released to enable the cassette to be removed. With the print head in the operative position, an image may be formed on the image receiving tape as a result of collectively heating pixels on the thermal print head. In alternative embodiments of the present invention, the print head may be stationery and the platen moves between an inoperative and operative position. Once a message has been printed, the image receiving tape is fed out of the cassette to a cutting apparatus 44.

FIG. 6 shows as schematic diagram of the cassette 50. The cassette comprises a body 52 housing a supply of direct thermal tape 54. The direct thermal tape comprises a first side on which a printed image is formed and a second side comprising a releasable backing layer. The structure of the direct thermal tape is described in more detail hereinafter. The direct thermal tape is guided out of the cassette and through the print zone 56 between the platen and the thermal print head.

It is understood that other embodiments of the tape printer may be envisaged in which the receiving bay received a roll of direct thermal tape without the need of a cassette as shown in FIG. 7. This may reduce the cost of replacing the tape supply. However, the use of a cassette to house the tape ensures that the tape remains in good condition both during storage and when introduced into a printer for use. It is also preferably that the cassette be light tight as excessive exposure of light to some tapes may have an adverse effect. In some embodiments of the invention, the tape is wound on the tape supply roll so that the thermally sensitive surface is inwards of the tape with the backing layer radially outwards.

The direct thermal tape for use in the tape printer embodying the present invention comprises direct thermal printing media of the type utilized in the field of photography and discussed in the pre-amble of this specification with reference to FIGS. 1 to 3. While conventional tape printers capable of colour printing utilize separate donor and receiver tapes, in the present invention the thermally activated chemistry is incorporated into a single tape. FIG. 8 shows a schematic diagram of direct thermal tape according to an embodiment of the present invention. The tape comprises a removable base layer 70, an adhesive layer 72, a substrate layer 16, a print layer 73, and an overcoat layer 74. The print layer comprises a plurality of colourless dye precursors in order to form a direct thermal tape capable of producing a full multicoloured image. In this embodiment the different colourless dye precursors are provided in separate image-forming layers 18, 20, 22 with spacer interlayers 24, 26. After printing a label, the removable base layer may be removed to expose the adhesive layer for attachment of the printed label to a surface.

During printing, the print control means in the form of a processor controls the print head whereby dyes of different colours are selectively reacted to produce a multicoloured image. The criteria for selective reactivity depend on the thicknesses of the tape layers, the thermal conductivity of the layers, the temperature coefficients of reaction for the dye precursors, the heating temperature and the heating time. It is envisaged that a number of image-forming techniques may be exploited including thermal diffusion with buried layers, chemical diffusion or dissolution in conjunction with timing layers, melting transitions and chemical thresholds. Selective light activated reactions may also be utilized in order to achieve multicolour colour printing.

During printing, the processor controls the print head and in particular, the temperature of each print head pixel is controlled according to data input from the keyboard, PC or other input device. The temperature or energy of each pixel is continuously variable whereby an image of continuously variable optical density and/or colour may be produced. The processor also controls the print head strobe time, that is the width of a pulse and/or the number of pulses. The control of the heating temperature and the heating time allows a multi-coloured image to be produced on the direct thermal image tape.

The printer and the tape are adapted to produce a multicoloured image on the tape by direct thermal transfer in a single pass of the tape, that is no reversing of the tape is required. The processor is adapted to control the printing elements according to data input to the tape printer by a user. For example, a user can select different colour schemes for a label via the keyboard. The processor controls the temperature and the time period each printing element is heated and the temperature of each element is continuously variable. In some embodiments, the energy can be varied in a stepwise fashion rather than continuously.

A memory is provided for holding temperature, heating period and colour data which is accessible by the processor to select a temperature and heating period for each printing element according to data input to the printer. The memory may hold temperature, heating period and colour data for different types of direct thermal tape as well as for thermal transfer tapes (which use an ink ribbon). In one embodiment the printer has a detection means for detecting the type of direct thermal tape inserted in the printer (for example, it could be a two colour tape or a full multicolour tape) or if it is a thermal transfer tape and the detecting means sends a signal to the control means whereby the data corresponding to the detected tape type is selected. In this way, a tape printer can be used for several different embodiments of direct thermal image tape. The detection means may be physical e.g. the tape cassette may activate a switch according to the shape of the body of the cassette when introduced into the printer. Alternatively, it may be electrical, optical, RF, magnetic, in the form of markings or may be selected by a user manually.

The above-described embodiments enable a method of printing a label in which a multicoloured image is produced on the tape by direct thermal transfer in a single pass of the tape past the print head. In particular, the use of such a method solves the problem of alignment between an ink ribbon and a receiving tape and also solves the problem of ink ribbon creasing. As a result, higher quality colour images are achieved.

Reference is now made to FIG. 9 which shows four examples of face material which can be used in embodiments of the present invention. Some of these embodiments are the same or similar to those embodiments described previously. In the following, those layers which are the same are referenced by the same reference numbers.

Reference is made first to FIG. 9a. In this arrangement, there is a clear carrier film 106. On one side of the clear carrier film is a layer 108 containing cyan dye or the like. Overlying that cyan layer 108 is a bottom over-layer 110. This is a protective layer which may be a polymeric binder in which small molecules are dissolved or dispersed.

On the other side of the clear carrier film is a layer 104 containing magenta dye. On top of that magenta layer is a further layer containing yellow dye 102. That yellow layer 102 is overlaid by a protective over-layer 100 which is similar to the bottom over layer 110. This defines a first face material 116a.

Reference is now made to FIG. 9c. This face material construction 116c has a similar construction to that shown in FIG. 9a. However, the over-layer 100 has been replaced by a clear protection film 112. The clear protection film 112 is adhered to the layer containing the yellow dye by an adhesive layer 114. That adhesive layer is clear. The clear protection film may be a thin transparent layer of polyolefin or polypropylene or any other suitable material, typically having a thickness of a range 3 to 15 micro metres for example. The clear protective film may optionally have a wax coating. The clear protective film may be coated in a friction reducing material.

Reference is now made to FIG. 9b which shows a further embodiment of the face material. The face material comprises a clear carrier film 106. On that clear carrier film 106 is provided a layer 108 containing cyan dye. This has a layer 104 containing magenta placed on top of it. On the magenta layer 104 is a layer 102 containing yellow dye. The layer containing the yellow dye 102 has a protective over-layer 100 placed on top of it.

FIG. 9d shows a modification of the embodiment shown in FIG. 9b. The over-layer 100 of FIG. 9b has been replaced by a clear protection film 112 which is adhered to the yellow layer 102 by a clear adhesive 114. This is as already described in relation to FIG. 9c.

The embodiments shown in FIG. 9 have a clear carrier film. In some embodiments of the invention, the carrier film may be opaque and coloured. Alternatively the carrier film may be transparent and coloured. The embodiments of FIG. 9 may be modified to include space layers or the like between the coloured layers. Three coloured layers are shown. In alternative embodiments of the invention, there may be only two or one coloured layer. The adhesive layer may be opaque and/or coloured in alternative embodiments of the invention. The cyan layer is show on a different side of the carrier to the yellow and magenta layers in some embodiments. In alternative embodiments of the invention, the yellow or magenta layers may be provided on the other side of the carrier layer to the other two coloured layers. Embodiments of the invention have shown coloured layers with magenta, cyan and yellow. It should be appreciated that in alternative embodiments of the invention there can be different colours in the layers. Depending on the technology used, it is possible that the dyes or the like can be incorporated in a single layer or two or more colours can be produced from the same layer.

Reference is made to FIG. 10 which now shows various embodiments of the label material and how it is used in label in label printers in preferred embodiments of the present invention.

Reference is now made to FIG. 10a which shows an embodiment. In this embodiment, two supplies of material are used. The first supply 128 comprises the face material 116. To the bottom over-layer or clear carrier film is applied a layer of white ink 118.

The second supply of material comprises a double sided silicon liner 122. One side of the silicon liner layer 122 is provided a layer of white adhesive 120. As can be shown seen from FIG. 10a, the first supply 128 is provided on a roll. In use, once a label has been printed, the thin silicon liner layer can be removed. This will leave the white adhesive layer exposed and the label can be stuck to any suitable surface. In alternative embodiments of the present invention, the adhesive layer may not be white.

The label material 124 of FIG. 10a may be provided in a roll 124. Depending on the embodiment of the present invention, the roll may be accommodated in a tape cassette as discussed previously. However, this is not necessary and in alternative embodiments of the present invention, the label material may be provided simply in a roll. The label material is then provided to a print station 126 where printing can be carried out. Various examples of print stations will be described later. The second supply material 130 is also provided in a roll or alternatively in a cassette. In some embodiments of the present invention, a common cassette may be provided for both of the supplies 128 and 130. The material 130 is provided together with the material 128 to a pair of rollers 132 and 134. These rollers act together to apply the white adhesive and silicon liner material 130 on one hand to the face material and white ink layer on the other hand, to thereby provide a single label. The white ink layer 118 is adhered to the white adhesive layer 120.

It should be appreciated that one or both of the rollers 132 and 134 may be driven. In alternative embodiments of the present invention, a single roller may be used with that single roller acting against a fixed surface.

Reference is now made to FIG. 10b which shows a further embodiment for the label material. The face material 116 is provided as one separate supply. As a different supply is provided a material comprising an adhesive layer 190. Attached to one side of the adhesive layer 190 is a white film 192. Attached to the other side of the white film 192 is an adhesive layer 193 which is attached to a double sided silicon liner 194. Silicon is provided on both sides of the liner. This defines a backing supply 196. The backing supply 196 and face material 116 can be provided on rolls, in a common cassette, or in separate cassettes. As with the arrangement shown in FIG. 10a, the image is printed on the face material 116 at a print station 126. After printing, the backing material 196 is applied by a pair of rollers 132 and 134 to the face material 116.

Reference is now made to FIGS. 11a to d which show various different constructions of the print station.

Reference is made first to FIG. 11a. In FIG. 11a, there are two print heads 140 and 146. The first print head 140 acts in conjunction with a platen 142. This first print head 140 is arranged to control the yellow and magenta printing with the material shown in FIGS. 9a and 9c. The second print head 146 also operates in conjunction with a platen 144 in the form of a roller. The second print head 146 is arranged to control the printing in the cyan layer 108 in the arrangements of FIGS. 9a and 9c. It should be appreciated that this same arrangement may also be used with the embodiments shown in FIGS. 9b or 9d. In some alternative embodiments of the present invention, the two print heads 140 and 146 may be arranged to contact the same side of the label material to print the image. In this latter embodiment the two print heads would be preferably but not necessarily arranged to contact the top over-layer or clear protective film depending on the construction of the face material.

In the arrangement of FIG. 11a, the print head is fully addressable. This means that the print head contains n printing elements each of which is separately controllable. Effectively, this means that a drive circuit is provided for each printing element so that for any given printing operation the printing element can be controlled to be on or off. In FIG. 11a the print head has a height x which corresponds to the maximum width of label to be used with the tape printer. In general, the text will have a maximum height y which is less than the maximum label height x. The term text is used to refer to any image which is printed over a background image and may be text, symbols, numbers, graphics, drawings or the like. This is because there will generally be a space above and below the characters on a label. It should be appreciated that the term “text height” refers to the height of a line of text where the label contains a single line of text or where the label contains more than one line, the height from the top of the first line to the bottom of the last line.

Reference is made to FIG. 11b which shows a modification to the arrangement of FIG. 11a. The arrangement of the FIG. 11b shows two print heads 148 and 154 in conjunction with respective platens 150 and 152 in a similar arrangement to that shown and described in relation to FIG. 11a.

Reference is made now to FIG. 12 which shows how the print heads of FIG. 11b are controlled. In FIG. 12, six printing elements 180a-f are shown. This is highly schematic. In practice many more than six printing elements 180 are provided. These printing elements 180 have together provide a height x which is equal to the maximum width of tape used with the tape printer. Pixels 180c and 180d together provide the part of the print head will be used to print text and thus have a height y. This means that the two pixels 180a and 180b above the two pixels 180c and 180d will be used to provide an image above the text and the two pixels 180e and 180f will be used to provide the image below the text. Typically this image will be a background colour, background pattern or the like as will be discussed in more detail hereafter. In the embodiment shown in FIG. 11d, the pixels which are used to generate text that is pixels 180c and 180d, each are provided with their own drive circuit 182b and 182c. The drive circuits 182b and 182c are controlled by a controller 184. Since each of the two pixels 180c and 180d has their own drive circuit, they are independently and separately controllable. In other words, they can both be on both be off or only one of the two on. However, for the two pixels above the text, that is pixels 180a and 180b, a single drive circuit 182a is provided which is again controlled by the controller 184. This means that these two pixels will either both be on or both be off. It is not possible to separately control these two pixels.

Similarly, for the two pixels below the text, that is pixels 180e and 180f, again a common drive circuit 182d, controlled by the controller 184, is provided. Again, this means that the two bottom pixels with either both be on or both be off. It is not possible to separately control these pixels.

As mentioned previously, FIG. 12 is schematic in that in practice many more than six pixels are provided. The advantage of the arrangement shown in FIG. 12 is that the cost of the drive circuitry provides a substantial cost of the print head circuitry. By reducing the number of drive circuits required, the cost of the print head can be significantly reduced.

In the arrangements of FIGS. 11a and 11b, the two print heads together provide both the background and the text. Thus, the background can have any suitable colour or pattern and the text can have any suitable colour or colours. In both of these embodiments, the two print heads will have the same construction in the respective embodiments.

Reference is now made to FIG. 11c and FIG. 11d where the printing process is effectively divided up into two stages. In a first stage the text is printed in the desired colour or colours on the tape and then a background is applied to the tape. In alternative embodiments of the present invention, the background to the text may first be applied and then the image.

In the arrangement shown in FIG. 11c, the text is printed on to the tape using a print head 173 in conjunction with a platen 172. The print head will have the same print head structure as described in relation to FIG. 11a.

The tape will then be provided to a two print head arrangement comprising a first print head 168 and associated platen 164 and a second print head 160 and associated platen 162. This arrangement is the same as described in relation to FIGS. 11a and b. However, in the arrangement shown in FIG. 11c, the print heads are arranged to provide a colour background. Accordingly, the print head has a very much simpler construction in that all of the printing elements are controlled to be either on or off and if on, the energy level and duration is appropriately controlled dependent on the required colour. It should be appreciated that the print head can in effect be replaced by an element which can be heated up to the required temperature for the required duration. The term print head is intended also to cover any such element.

FIG. 11d shows a modification to the arrangement of FIG. 11c in that the two print heads are now arranged to be aligned with each other so that the need for the platens can be removed. The two print heads 174 and 176 have the same construction as the print heads 160 and 168 described in relation to FIG. 11c.

The arrangements shown in FIGS. 11c and 11d can be modified so that a single background applicator in the form of a single print head is provided. Thus the arrangements shown in FIGS. 11c and 11d can be simplified to provide two print heads. One print head is arranged to provide the text or the like on the label and the other print head is arranged to provide the background colour or image. The position of the print head will be determined by the nature of the material. For example, if the full colour image can be achieved by print heads acting from the same side of the material, then the print heads can be provided side-by-side. Alternatively, if the material is such that printing can be achieved from either side of the material, then the two print heads may be provided in alignment with each other, thus avoiding the need for a platen and also providing a compact arrangement. In other words, the print heads act as a platen for the oppositely positioned print head.

It should be appreciated that depending on the structure of the material, the number of print heads used can be one, two or three. It should also be appreciated that embodiments of the present invention can be used with direct thermal materials which provide more limited colour images. For example, embodiments of the present invention can be used with di-chromic or tri-chromic materials. In those cases, the number of print heads and print head control may be simplified.

It should be appreciated that tape printers embodying the present invention can be used to provide colour images but can also be used with thermal material to provide a single printing colour with no variability in the background colour. In other words, the tape material will have a predetermined colour and an image can be printed in a single colour usually black.

Tape printers embodying the present invention can also be arranged to do thermal transfer printing, that is using an ink ribbon. FIGS. 11c and 11d show where the thermal transfer cassette would be used. In particular, the thermal transfer cassette would be positioned so that the image is printed on the tape using the print head where each printing element is individually controllable.

Reference will now be made to FIG. 13 to show how a user is able to select the desired colour. The user would operate a function key or keys in order to access colour options. In one embodiment, a colour function key 210 is actuated to provide the menu shown in FIG. 13a. Using the cursor, the user is able to move between background and text. When background is highlighted, the menu shown in FIG. 13b is shown. In order to get to the menu shown in FIG. 13b, the user would move the cursor until the background option is highlighted. The user would then activate a confirmation key such as an OK key or ENTER key. This would then provide the menu shown in FIG. 13b. The user is able to scroll through the various different colours available to the user. To select a colour, the user would activate a confirmation key such as an OK key or ENTER key. This would then take the user back to the menu shown in FIG. 13a. The user can then move the cursor down to the text option. If the confirmation or OK key is actuated, then the menu shown in FIG. 13c will be displayed. In the same way as described in relation to the background colour, the text colour can be selected. Once the OK key has been pressed, then the user returns to the menu shown in FIG. 13a. A further actuation of the OK or confirmation key will take the user back to the edit screen and the user can input an image to be printed.

In one embodiment of the present invention, the menu shown in FIG. 13a may show the currently selected colours for the background and text.

In another embodiment of the present invention the user may be able to view the choice of colours available to the user by viewing a printout of the available colours. This may be achieved by selecting a ‘colour palette’ option from a menu or by selecting the appropriate key on the keyboard. When the colour palette option is selected the printer may be arranged to print out the available colours together with the name of each colour, so that the user is able to identify the colours printed out by name. This embodiment of the present invention is particularly useful when a monochrome display is used, or when the display is unable to display the full range of colours available to the user.

In another embodiment of the present invention, the display may be a colour display and when the user inputs text, the text will have the selected colour on the display. Likewise, the background of the display will also have the required colour.

Alternatively, in a further embodiment of the present invention, the colour display may be arranged to display a grid or ‘matrix’ of colours, each region of the matrix displaying a selectable colour. In this embodiment the matrix of colours may be displayed in place of the menus shown in FIG. 13b and 13c. Accordingly, after the user has selected either ‘background’ or ‘text’ from the menu shown in FIG. 13a, the printer may be arranged to display the colour matrix. Using the cursor keys the user may be able to select a colour by placing the cursor on the region of the matrix displaying the desired colour. The printer may be further arranged to also display the name of the colour on which the cursor is placed.

It should be appreciated that some displays may only be able to display one or two lines of text. In that case, the menus shown in FIG. 13a would not be displayed but the options would be viewed by the user moving the cursor downwards.

In some embodiments of the present invention, the tape printer may be connected to a PC. In those embodiments, the tape printer may not have a keyboard or display. However, in some embodiments the tape printer will additionally have the display and keyboard. In the embodiments where the tape printer is connected to a PC, relatively complicated colour images can be downloaded from the PC to the tape printer for printing. These can be full colour images.

Reference is now made to FIG. 14. FIG. 14 shows how the user can select the background for the tape. Using one of the function keys, the user is able to get to a background menu as shown in FIG. 14a. This lists the various options for background. By way of example, the user can have no background, a patterned background, a plain background (i.e. a particular colour) or a text background. Using a cursor, the user is able to select one of these options. As described in relation to FIG. 13, the user moves a cursor down to the selected option and actuates a confirmation key or the like. If the user selects pattern as the option, then the menu shown in FIG. 14b is displayed. As can be seen, the user has options such as a shaded background, a dotted background, a background with stars or a background with stripes. This is entirely by way of example only and any other suitable pattern can be used as a background. To select a particular pattern, the user presses the cursor to highlight the selected option and then presses or actuates a confirmation key. If the user selects the text option, then the menu shown in FIG. 14c is shown. In particular, a message to the user is provided such as input text or a blank screen. In either case, the user inputs the text which will be displayed as the background. To confirm the input text, the user will actuate or press the confirmation key.

If the user selects the plain background, then the user may be taken to the menu shown in FIG. 13a.

It should be emphasised that embodiments of the invention are not limited to the examples of the tape materials given in this application. Embodiments of the present invention can be used with full colour direct thermal materials or with direct thermal materials which give a selection of two or more possible colours.

Preferred embodiments of the present invention are arranged so that information is automatically provided to or detected by the tape printer about the capabilities of the material. In other words whether the material is full colour, a thermal transfer material, a direct thermal material only providing one colour or a colour direct thermal material providing two or more colour options and if so what those colour options are. This information can be provided in a number of different ways. For example, the tape supply and/or cassette may have an element which provides the necessary information. In alternative embodiments of the present invention, the user may be able to set this from the keyboard. In other words, the user will provide the tape printer with information as to the type of tape material so that the tape printer can be controlled accordingly.

In embodiments of the preset invention, when the tape printer has received information that a colour direct thermal material is provided, then it can for example automatically display the colour and background text menu shown in FIG. 13a so that the user can keep the current settings or change those settings.

Reference is made to FIG. 17 which shows two labels 400 and 402. Label 400 has been heated to provide a first background colour whilst the second label 402 has been heated to provide a different background colour. As indicated by reference 404, there may be a region between the two labels where the colour is a blend between the two colours or the boundary between the colours is not clear. It may be difficult in practice to achieve a clean line between two colours. To address this problem, the region 404 is bounded on one side by a first cut 406 and on the other side by cut 408. Both of these cuts may be full cuts, that is the cut extends through the tape and any backing tape in its entirety to fully separate the two labels. In preferred embodiments of the present invention, one of these cuts is a partial cut, that is the cut is made only through part of the tape which is to be adhered to the surface and not the backing layer which is discarded. This partial or tab cut is in itself advantageous in that it is easy to remove the label from the backing tape.

In some embodiments of the present invention, the two cuts may be partial cuts. This may be desirable where a strip labels is required to be printed, where the labels are not completely separated. This may make for ease of transport. Each of the labels may be removed from the backing layer, with the region 404 as defined by the cut on either side, remaining on the backing tape for easy disposal.

It should be appreciated that when the first label 400 is separated from the second label 402, the downstream label 402 may also be provided with the partial cut and full cut at its downstream end.

In this way, the region where the colour is not well defined will be discarded.

In one embodiment of the present invention the printer may be arranged to print on the region 404. The region 404, which does not comprise part of the label, may then be used to present information to the user.

One example of information that could be printed in region 404 would be to provide an indication of the amount of tape remaining in the cassette. This may be achieved by referring to a memory location either in the microprocessor 200 or in a separate memory storage which may be provided, for example, on a processor or RF tag located on the cassette or in a host computer. The amount of remaining tape may be read from the memory location and printed on region 404 during the printing operation of the label.

Further examples of information which may be printed on region 404 include: printing a serial number numbering each label of a series of labels; printing arrows to indicate where the tab cut is located; and printing advertising information, such as a website address.

Mechanisms for providing partial and full cuts are known and in this regard reference is made to our earlier patents EP 578372, EP 711670, EP 607027 and EP 711637, which are hereby incorporated by reference.

FIG. 18 schematically shows one arrangement for providing a tab cut. The arrangements comprises a common holder 410 which holds a first blade 412 and a second blade 414. The first blade 412 is arranged to provide the partial cut whilst the second blade 414 is arranged to provide the complete cut. The two blades 412 and 414 act against an anvil 416. The partial cut blade 412 is arranged so that it does not extend as far down as the blade 414 for providing the complete cut. This is indicated by distance 418. The difference between the lowest points of the two blades 412 and 414 represents the thickness of the backing layer of the tape. The common mechanism 410 is arranged to move the two blades 412 and 414 downwards so that the blades act against the anvil 416. A tape will of course be provided between the blades and the anvil 416. In this way, a full cut and a partial cut may be provided. The mechanism for providing the full and partial cut can be varied as required. Instead of providing an up and down motion to provide the full and partial cut, a rolling motion where the blades carried out rolling motion to bring them into and out of contact with the tape. This is described in our patent number EP 711637.

In alternative embodiments of the present invention, the cutting operation can be a two stage operation, with a single blade providing the full cut and the partial cut.

Reference is made to FIG. 22 which shows a detailed example of the implementation of one embodiment of the invention. Shown in FIG. 22 are the relative positions of a first print head 600 and associated platen 602. Downstream of the first print head 600 is a second print head 604 and its associated platen 608. Downstream of the second print head 604 is the tab cut blade 610. Downstream of the tab cut blade 610 is the full cut blade 612. The various steps performed are shown with the position of the tape relative to the components shown.

In step S1, the tape has a tab cut 614 and down stream of the tab cut portion is part of the background 616 used in the previous label.

In step S2, the tape is reversed so that the first print head can start printing the background image for the next label between the tab cut and end of the label. The tab cut needs to be positioned before the first printing line for the background image.

In steps S3-S5, the background image of the label is printed. When the tape reaches the second print head, the overlying image is printed as shown in step S5. The background printing and printing of the overlying image can take place at the same time but on different parts of the tape.

In step S6, the background image has been completed so the first print head is inactive. The second print head continues to print until the overlying image has been completed.

In step S7, the label on which both the background image and the overlying image has been printed is fed to the cutting position and the tab cut blade activated.

In step S8, the tape is reversed slightly and the full cut blade activated. This is because it is difficult to cut on the last line that is printed. The full cut is therefore performed at a distance less than the label length. This means that part of the printing will then be on the tab cut portion.

Step S9 is the same as step S2 but for the next label.

Reference is made to FIG. 19 which shows a label with background printing (ABC LTD constitutes the background image). For clarity, the image printing on top of the background printing has been omitted. In this embodiment, it can be seen that the background image which can be words, a pattern, a plain colour or the like is arranged to extend across the full width of the tape. Thus when printing across the width of the tape it can be ensured that the background covers the entire width of the printing and does not leave a blank space between the edge of the tape and the printed background image.

To ensure that printing occurs across the entire width of the tape, ie the dimension of the tape parallel to the longitudinal axis of the print head it is necessary to ensure that the print head is long enough to extend the entire width of the tape. Where different widths can be printed on, the print head can be controlled to activate only those heating elements which are required to print on the width of tape present. To deal with tolerances in tape position and tape width, the print head may be controlled to print over a length slightly greater than the tape width. This may mean that printing may occur on the platen, with no tape between the platen and print head. This is illustrated in FIG. 20. The print head 500 is supported by a print head holder 504. The print head has a height 502. The tape 512 has a height 510. The height 510 of the tape 512 is less than the height 502 of the print head and the number of printing elements of the print head activated to be print a background image having a height at least the same size and preferably slightly larger than the width of the image receiving tape. Also shown in this Figure is the platen 506 and its support 508. The print head prints against the platen.

In embodiments of the invention, applied to die cut labels, the print head may be controlled to print over a length slightly greater than the width of the label. In this embodiment, the print head may simply end up printing on the label liner. This is illustrated in FIG. 21. The print head 500, print head holder 504, the platen 508 and platen holder 508 are as shown in FIG. 21. The height of the print head is 502, the height of the label is 516 and the height of the label liner 520 is 518. The print head is controlled to print a background image at least the same height as the label and preferably slightly greater. The height of the image is preferably less than the height 518 of the label liner.

It should be appreciated that embodiments of the invention are applicable to continuous tape and also, where appropriate die cut labels arranged on a continuous backing layer.

1. A label printer for printing on a direct thermal tape in a plurality of colors, said label printer comprising:
at least one print head for printing an image on said tape in said plurality of colors said image comprising text and a background; and
an interface for selecting at least one background color and at least one text color.

2. A printer as claimed in claim 1, wherein said interface comprises a keyboard.

3. A printer as claimed in claim 1, wherein the printer is arranged to permit the user to select a single color for said image and a single different color for said background.

4. A printer as claimed in claim 1, wherein said background comprises one of a pattern, text, image and plain color.

5. A label printer as claimed in claim 1, said label printer comprising:
at least one print head for printing a background image; and
at least one different print head for printing a text image.

6. A label printer as claimed in claim 1 further comprising a controller so that the background is printed in a first color and an image is printed in a second color.

7. A label printer for printing on a direct thermal tape in a plurality of colours, said label printer comprising; at least one print head, said print head having a plurality of printing elements, wherein at least some of said printing elements are individually controllable and at least some of said printing elements are commonly controlled.

8. A label printer of claim 7 said print head having a number of printing elements such that the print head can print across the entire width of said tape, said print head having a plurality of printing elements which are individually controllable, said individually controllable printing elements corresponding to a part of the print head which is arranged to print an image on said tape and at least one group of printing elements which are commonly controlled and which correspond to a part of the print head which is arranged to print a background on said tape between said image and at least one of said upper and lower edges of said tape.

9. A tape supply for use in a tape printing apparatus, said tape supply comprising a roll of direct thermal image tape, said direct thermal image tape comprising a plurality of thermally activated colourants and at least one developer for producing a multi coloured image on said direct thermal image tape when said direct thermal image tape is heated.

10. A tape supply of claim 9 said tape further comprising an outer protective layer.

11. A tape supply as claimed in claim 10, wherein said protective layer comprises polyolefin or polypropylene.

12. A tape supply as claimed in claim 10, wherein said protective layer is arranged to contact a print head in use.

13. A tape supply of claim 12, wherein said protective layer has a thickness of between 3 and 15 micrometers.

14. A tape supply of claim 13, wherein a removable backing layer is provided, opposite to said protecting layer.

15. A tape supply of claim 14, wherein a portion of said tape supply is cut off to form a label.

16. A tape supply of claim 10, wherein a top surface of said protective layer is coated with a friction reducing material.

17. A tape supply of claim 9, wherein said thermally activated colourants comprise dyes.

18. A tape supply as claimed in claim 17, wherein said dyes comprise leuco dyes.

19. A tape supply of claim 18, wherein each respective thermally activated colourant has a different activation temperature at which a color is formed whereby in use any one of the thermally activated colourants can be individually activated to produce a color without activating the other thermally activated colourants.

20. A tape supply of claim 9, wherein said tape is adapted to produce a multi coloured image by one or more of thermal diffusion, chemical dissolution, melting transitions and chemical thresholds.

21. A tape supply of claim 20, wherein said tape comprises a substrate layer, and a print layer comprising an image-forming layer.

22. A tape supply as claimed in claim 21, wherein said image-forming layers comprise one or more of a dispersion of solid material, an encapsulated liquid, amorphous materials, solid materials, solutions of activatable materials and polymeric binders.

23. A tape supply of claim 20, wherein the tape comprises an upper image-forming layer being selectively activatable to produce a color by applying heat to the tape at a temperature T1 for a time period t1 and a lower image-forming layer being selectively activatable to produce a color by applying heat to the tape at a temperature T2 for a time period t2 wherein T1>T2 and t1<t2, whereby in use either of the upper or lower layers can be activated separately from the other.

24. A tape supply of claim 20, wherein said tape comprises a plurality of image-forming layers, wherein each respective image-forming layer contains a different thermally activated colourant.

25. A tape supply as claimed in claim 24, wherein said tape comprises one or more spacer layers, each spacer layer being disposed between said image-forming layers.

26. A tape supply as claimed in claim 25, wherein the one or more spacer layers comprise one or more of a thermally inert material, a material which undergoes a phase change on heating by a thermal print head, a thermal solvent and a polymeric material.

27. A tape supply as claimed in claim 25, wherein the thickness and the thermal conductivity of the one or more spacer layers is selected whereby in use any one of the thermally activated colourants can be individually activated to produce a color without activating the other thermally activated colourants.

27. A tape supply as claimed in claim 26, wherein said tape comprises: a substrate layer having an upper and a lower surface; a first image-forming layer disposed on the upper surface of the substrate layer; a first spacer layer disposed on the first image forming layer; and a second image-forming layer disposed on the spacer layer.

28. A tape supply as claimed in claim 27, wherein an adhesive layer is disposed on the lower surface of the substrate layer and a base layer is disposed on the adhesive layer, said base layer being removable to expose the adhesive layer for attachment of said tape to a surface.

29. A tape supply as claimed in claim 28, wherein a second spacer layer is disposed on the second image-forming layer and a third image-forming is disposed on the second spacer layer.

30. A tape supply of claim 18, wherein said tape comprises a plurality of developers, each developer having a different activation temperature.

31. A tape supply as claimed in claim 30, wherein each developer is disposed in a different image-forming layer in said tape.

32. A tape cassette for use in a tape printing apparatus, said tape cassette comprising a body housing a supply of direct thermal image tape according to claim 9.

33. A tape cassette as claimed in claim 32, wherein said cassette comprises an indicating means for indicating the type of direct thermal image tape housed in the cassette.

34. A tape cassette as claimed in claim 33, wherein said indicating means are arranged to provide information as to the colors available from said direct thermal image receiving tape.

35. A tape printer comprising a tape supply receiving portion for receiving a supply of tape, a print head comprising a plurality of printing elements for printing an image on a tape, a drive means for driving a tape passed the print head and a control means for controlling the plurality of printing elements, wherein the control means is adapted to control the printing elements for producing a multicoloured image on a tape or claim 9 by direct thermal transfer.

36. A tape printer according to claim 35, wherein said control means is adapted to produce a multicoloured image on a tape by direct thermal transfer in a single pass.

37. A tape printer according to claim 36, wherein said control means is adapted to control the printing elements according to data input to the tape printer.

38. A tape printer according to claim 37, wherein said control means is a processor.

39. A tape printer according to claim 38, wherein said control means is adapted to control the temperature of each printing element.

40. A tape printer according to claim 39, wherein said control means is adapted to control the time period each printing element is heated.

41. A tape printer according to claim 37, wherein said control means comprises a memory storing at least one of temperature, heating period and color data which is accessible to select a temperature and heating period for each printing element according to data input to the printer.

42. A tape printer according to 41, wherein said memory stores at least one of temperature, heating period and color data for different types of direct thermal tape.

43. A tape printer according to claim 42, wherein said printer comprises a detection means for detecting the type of direct thermal tape inserted in the printer and wherein the detecting means sends a signal to the control means whereby the data corresponding to the detected tape type is selected.

44. A tape printer as claimed in claim 43, wherein said tape printer is arranged to detect if a thermal transfer tape material has been installed in said tape printer and to control the tape printer accordingly.

45. A method of printing a label comprising driving a direct thermal tape passed a thermal print head and controlling the print head whereby a multicoloured image is produced on the tape by direct thermal transfer in a single pass.

46. In combination, a tape printer as claimed in claim 1, with a tape supply as claimed in claim 9.

47. A label printer for printing, said label printer comprising:
at least one print head for printing an image whereby a background of one label is different to that of a second, subsequent label; and
cutting means for providing a cut on either side of a region between said first and second labels, where said first and second backgrounds meet.

48. A printer as claimed in claim 47, wherein the at least one print head is arranged to print information on said region between said first and second labels.

49. A printer as claimed in claim 47, wherein at least one of said cuts is a partial cut.

50. A printer as claimed in claim 47, wherein at least one of said cuts is a full cut.

51. A printer as claimed in claim 48, comprising reversing means for reversing image receiving medium on which said labels are arranged to be printed.

52. A printer as claimed in claim 51, wherein said reversing means are arranged to reverse said medium from the cutting means to said at least one print head.

53. A printer as claimed in claim 49, wherein at least one of said at least one print heads is arranged to start printing an image on said image receiving medium on one side of a partial cut provided by said cutting means and to continue printing on the other side of said partial cut.

54. A printer as claimed in claim 47, wherein said cutting means is arranged to provide a cut, said cut being at a position such that one background extends both sides of said cut.

55. A printer as claimed in claim 54, wherein said one background extends only a relatively small distance on one side of said cut.

56. A printer as claimed in claim 47, wherein at least one print head is arranged to print backgrounds on said first and second labels in different colors.

57. A label printer for printing an image, said label printer comprising: at least one print head for printing on a tape a first image for a first label and a second different image for a second label, said first and second labels being adjacent; and cutting means for providing a cut on either side of a region between said first and second labels, where said first and second images meet.

58. A method of printing an image comprising the steps of:
printing a first label on a supply of continuous tape; and
moving the tape to a printing position for printing a second label, initial printing being on one side of a partial cut and subsequent printing being on another side of said partial cut.

59. A method as claimed in claim 58, comprising the step of:
cutting at least partially said tape when said image has been printed, said cut being through said image.

60. A method as claimed in claim 58, wherein said cut is through a background image.

61. A label printer for printing an image on a label, said printer comprising:
printing means for printing an image on said label, said printing means having a length, said length being greater than a corresponding dimension of said label, wherein when a background image is printed on said label, said printing means is controlled to print said background image over a length at least equal to said corresponding dimension of label.

62. A label printer as claimed in claim 61, wherein said printing means comprises printing elements and said printing means is arranged to print said background image by activating a number of printing elements sufficient to print said image over said length at least equal to the corresponding dimension of label.

63. A label printer as claimed in claim 61, wherein said background image is arranged to be printed over a length greater than said corresponding dimension of label.

64. A printer as claimed in claim 63, wherein said printer is arranged to print a colour image.
